(19) United States
(12) Patent Application Publication
(10) Pub. No.: US 2014/0007471 A1
(43) Pub. Date: Jan. 9, 2014

(54) Interlocking and Customizable Storage System

(71) Applicant: Alex Samuel Ottolenghi, Philadelphia, PA (US)

(72) Inventor: Alex Samuel Ottolenghi, Philadelphia, PA (US)

(21) Appl. No.: 13/543,761

(22) Filed: Jul. 6, 2012

(51) Int. Cl. G09F 19/00; B29C 45/40

(52) U.S. Cl. 40/1; 264/219

(57) ABSTRACT

An interlocking display module which may be removably coupled to an adjacent display module for creating a customizable storage system and method of making it. Each module is preferably formed through injection molding of ABS plastic into a rectangular solid shape with an open front and carries a projection (a dovetail in the preferred embodiment) on flanges on two of its sides (top and right side) while two other sides (bottom and left) carry a complementary recess on flanges, allowing one module to interlock with a similar module to form a customizable storage system. One use of such a storage system is for the storage and display of collectible items such as action figures, coins or stamps, model trains, toy soldiers or other toys.

### BACKGROUND OF THE INVENTION

1. Field of the Invention

The present invention relates to an improved storage and display system which is customizable using interlocking modules and method of making it.

2. Background Art

Various methods and systems of providing interlocking modules have been proposed in the art. Some of these are systems are difficult or costly to manufacture and some of them require multiple parts for a single storage module.

Some of the prior art systems also involve an intricate and/or complex assembly mechanism, which makes the assembly more expense to manufacture and assemble.

Requiring multiple parts means that multiple parts must be separately manufactured and inventoried, then assembled in the proper order and location.

Some of the display systems of the past have limited ways that they can be arranged, limiting the flexibility of arrangement which is desirable if display modules are to be arranged to fit a space which differs in size and arrangement in different situations.

Accordingly, it will be apparent to one skilled in the art that the prior art systems and methods for providing interlocking display modules have undesirable limitations and disadvantages.

### SUMMARY OF THE INVENTION

The present invention overcomes the disadvantages of the prior art systems for display of items such as collectibles by providing an interlocking module and method of making it which provides a simple, yet efficient, system of interlocking modules to form a customizable display of such modules.

The modules of the present invention are easily and inexpensively fabricated. They are easy to orient and assemble into the desired shape and maintain their assigned location within a display by resisting accidental disassembly and disconnection. The modules are nevertheless easy to disassemble when desired and stored or shipped in a disassembled arrangement or reconfigured to fit a different space arrangement when desired.

The present invention provides for several useful, but optional, additional features. For example, the display modules can have a mounting pedestal formed on an inside lower surface for the purpose of locating a displayed collectible in a fixed location. A backdrop or rear member may be easily inserted into the display module, if desired, allowing for scenery or a mirror to provide additional ambiance for the display. A transparent front covering could be added to the display module as well, if desired.

Other objects and advantages of the present invention will be apparent to those of ordinary skill in the art to which the present invention pertains.

### BRIEF DESCRIPTION OF THE DRAWINGS

FIG. 1 shows a front view of a first storage apparatus (or module) according to a first exemplary embodiment of the invention;

FIG. 2 shows a back view of a first storage apparatus according to a first exemplary embodiment of the invention;

FIG. 3 shows a front perspective view of a first storage apparatus according to a first exemplary embodiment of the invention;

FIG. 4 shows a top view of a first storage apparatus according to a first exemplary embodiment of the invention;

FIG. 5 shows a bottom view of a first storage apparatus according to a first exemplary embodiment of the invention;

FIG. 6 shows a first (left side) side view of a first storage apparatus according to a first exemplary embodiment of the invention;

FIG. 7 shows a second (right side) side view of a first storage apparatus according to a first exemplary embodiment of the invention;

FIG. 8 shows a first storage apparatus connected to a second storage from a front perspective view according to a second exemplary embodiment of the invention; and

FIG. 9 shows a plurality storage apparatuses connected together from a front perspective view according to a third exemplary embodiment of the invention.

### DETAILED DESCRIPTION OF THE PREFERRED EMBODIMENTS

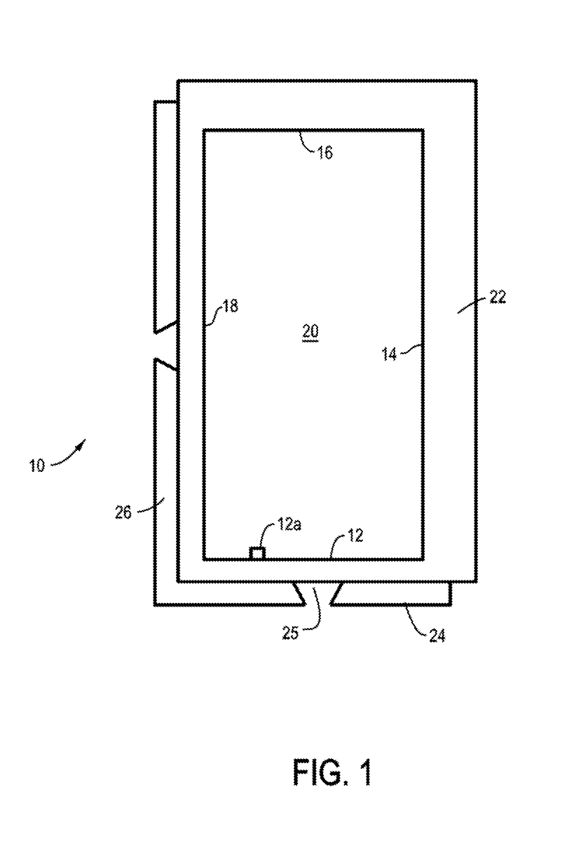

FIGS. 1-7 illustrate typical features of a customizable, interlocking module 10 of the present invention. The customizable, interlocking module 10 is shown as a rectangular solid which includes a base 12, a right side 14, a top side 16, and a left side 18. Referring first to FIG. 1, the module 10 is shown with an optional back surface 20. A bottom flange 24 is shown with a dovetail-receiving recess 25 and a left flange 26 is shown with a second dovetail-receiving recess 27. The rectangular solid module 10 has an interior space defined by peripheral walls 22 which extend around the module 10. A mounting pedestal 12a projects upward from the base 12 to provide a locating and securing mount for collectibles, such as action figures. The action figures often are formed with an aperture extending into the figure, and the mounting pedestal 12a is dimensioned so as to facilitate fitting within the aperture of the action figure or other collectible. The base 12 can also be formed with a slot (not shown in FIG. 1) to serve as a holder for a coin or other display item associated with the action figure, either as a part of a single pedestal or as a separate pedestal, since some collectibles include an auxiliary item which some may wish to display together with the collectible.

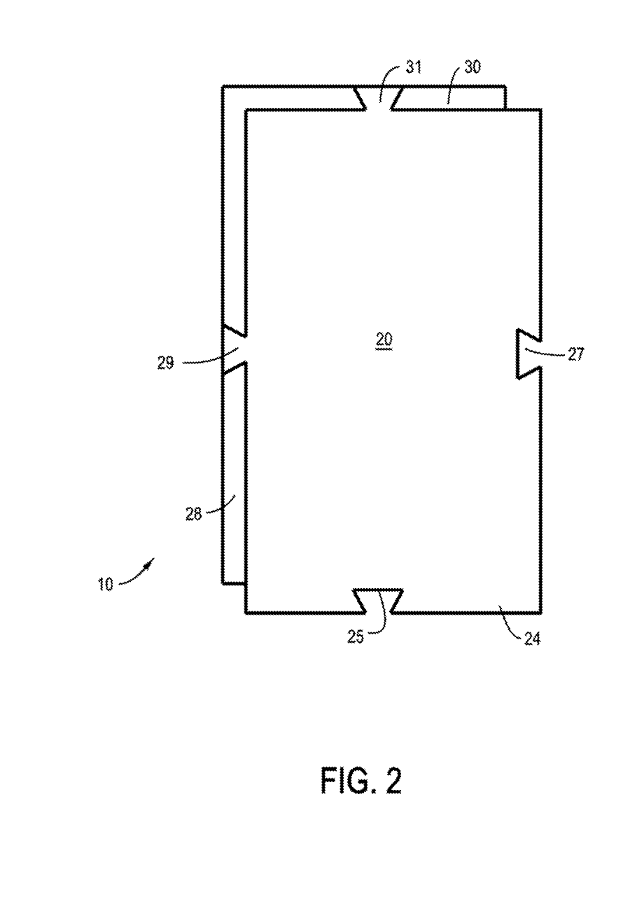

The back side of the module 10 is shown in FIG. 2 and shows not only a back surface of the back 20 of the rectangular solid module, but also the dovetail-receiving recesses 25, 27 shown in FIG. 1. On the left side of FIG. 2 (which is the right side of the module of FIG. 1) there is a flange 28 and a dovetail projection 29. The top portion of the module 10 includes a flange 30 and a dovetail projection 31.

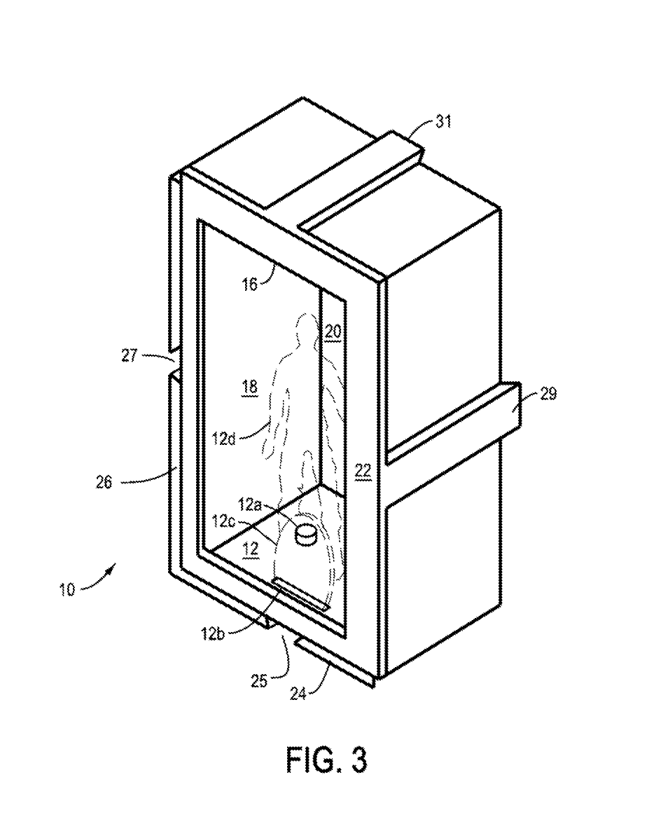

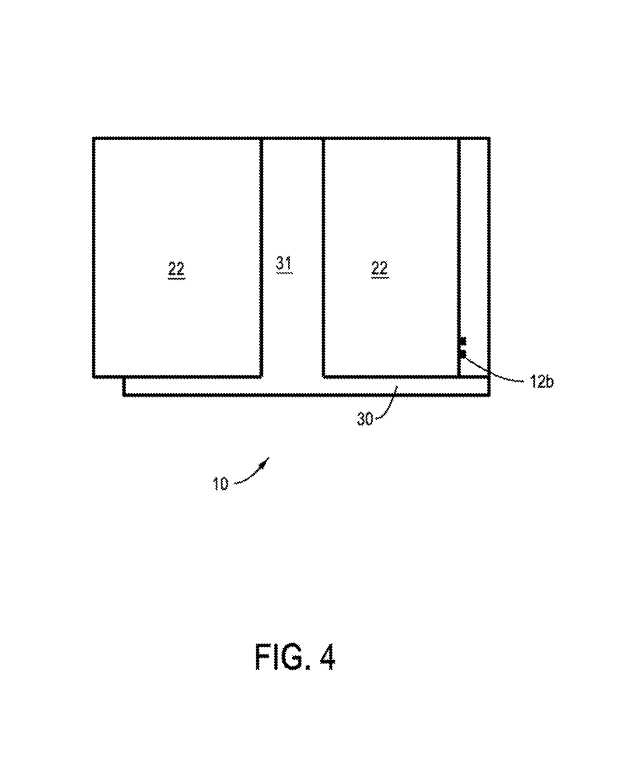

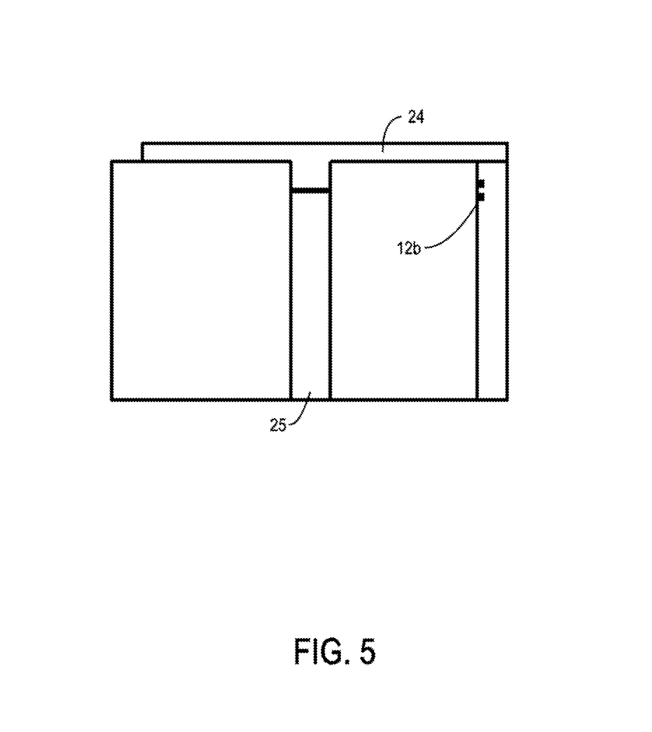

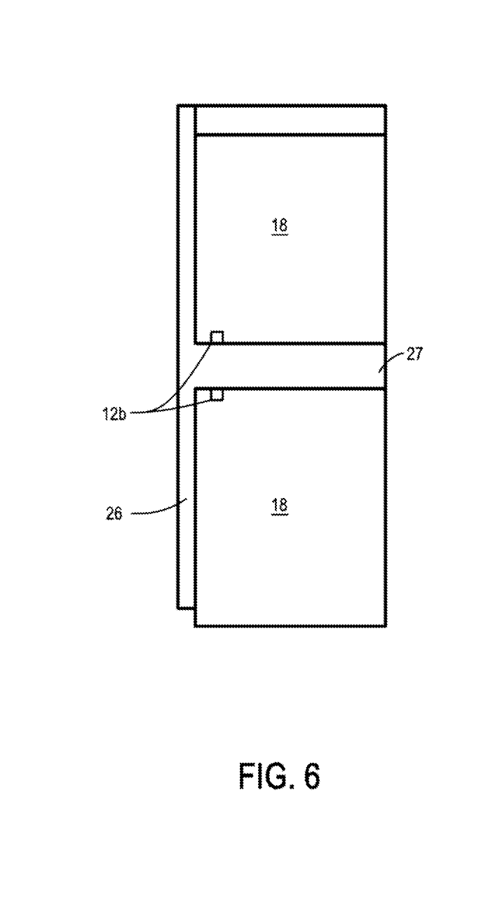

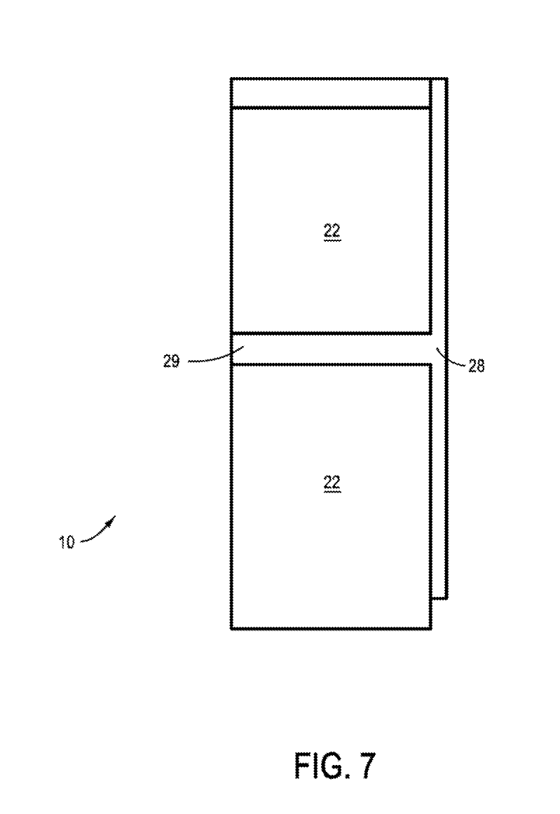

FIG. 3 shows a perspective view of the module 10 of the present invention, taken from the front and right side. An optional action FIG. 12b (which may be sold separate from the module 10 of the present invention) is shown by a dotted line 12d and mounts to the pedestal 12a in FIG. 3. An optional coin 12c (again, which may be sold separately from the present display case) is shown by a dotted line mounted within the slot 12b. FIGS. 4 and 5 show top and bottom views of the module 10, respectively, and FIGS. 6 and 7 show details of two different side views of the module 10.

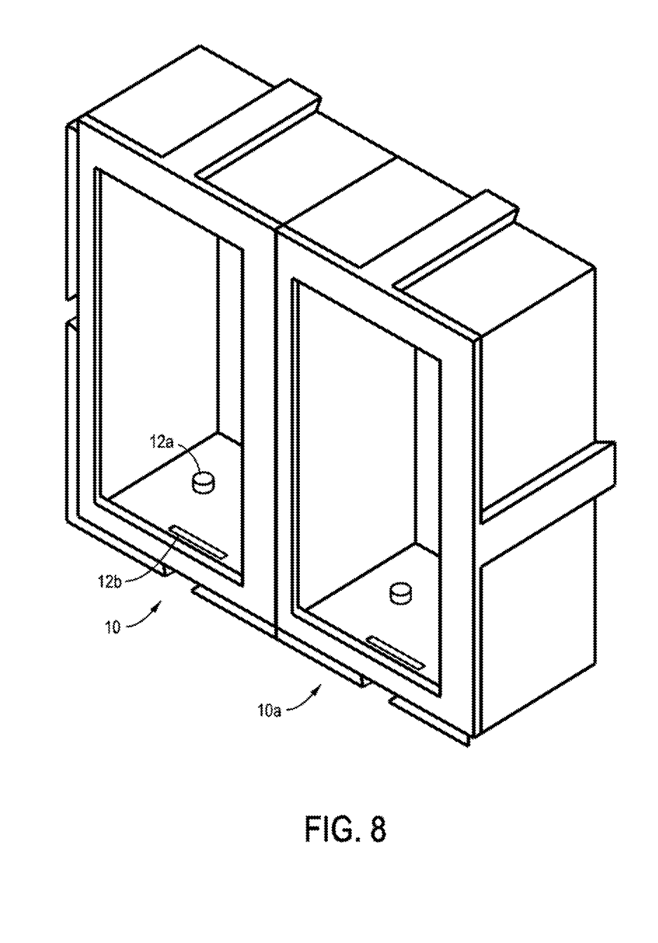

FIG. 8 shows the module 10 mated with a second, similar module 10a. A dovetail projection from the right side of the module 10 (not seen in this view) fits within the dovetail-receiving recess on the left side of the second similar module 10a to create an interfitting arrangement.

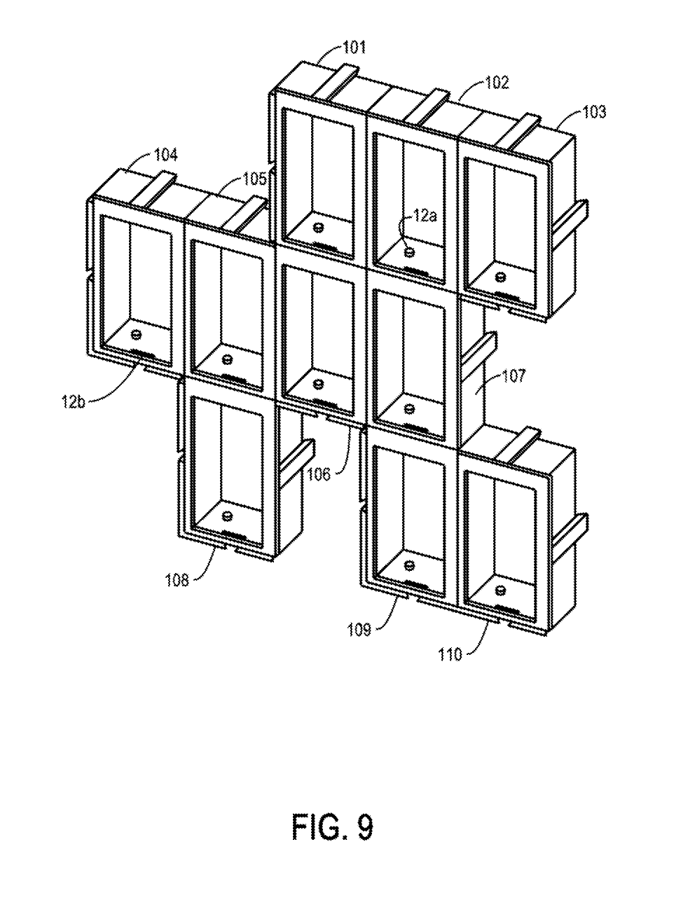

FIG. 9 shows an optional configuration of modules to form a customizable storage system example of the present invention. Ten modules labeled as 101-110 have been interconnected to form an array of modules in a connected illustration of the present invention. The module 101 is connected using its right dovetail projection fitting into the dovetail receiving recess of the module 102. The module 101 is also connected to the module 106 below it using the dovetail projection on the top of the module 106 interfitting within the dovetail-receiving recess on the bottom of module 101. A gap of the approximate size of module is formed on the bottom row between the modules 108 and 109 simply by not connecting any module to the bottom of module 106. A similar gap is created to the right of the module 107, and a gap the size of approximately 2 modules is formed to the right of the module 101. Of course, the number of modules high or wide is a subject of choice as is the size of the gaps (if any) left in the storage assembly.

Manufacturing of this module may be accomplished using one of a variety of known techniques and one of a variety of materials. It is thought that injection molding of plastic, particularly ABS plastic, is the most effective and efficient way to form the module, but other materials (such as other plastic, metals, alloys and similar materials) could be used to advantage if desired. Plastic can be injection molded as a single piece, although another version of the present invention could also be practiced with the module comprising more than one piece, for instance, a separate back member or interlocking pieces to form a single module 10. The use of plastics allows the advantage of making the mounting pedestal 12a and slot 12b in a single molding operation and in the form of a single piece, if desired, a process which can reduce the manufacturing cost and the number of steps in the manufacturing process.

The size of a typical module is chosen based on the size of the articles to be displayed. In one configuration of this invention, the size has been chosen to be approximately 4 inches tall, three inches wide and three inches deep, based on the item (in this case, a collectible) fitting comfortably within the aperture. If the items being displayed are generally larger than that, a larger size can be chosen, but if it is desired to display a small number of larger items with many smaller items, the few larger items can be accommodated by simply leaving a larger gap between modules.

The module 10 of the present invention may be enhanced by providing a backdrop in the back of the module, if desired. For example, scenery (for example, war scenes and/or equipment) or other suitable pictures can be mounted on a stock slightly smaller than the size of the back of the module and either positioned in place or secured there with temporary or permanent adhesive. In place of a pictoral backdrop, a mirror could be used to advantage in some displays to better show the back of the item being displayed, and again, the mirror could be merely positioned in the module or secured in place to restrict its motion. The present invention also could have a transparent front surface placed over the front of the module, if desired, to provide a way of captivating the things placed therein (such as the action figures and coins) from inadvertent loss or to secure them from removal by an unauthorized person.

The dovetail projection will be formed to a specific dimension and tolerance, and the dovetail recess will be formed slightly larger to permit the modules to easily interfit, but not so large as to allow for the modules to move a lot with respect to one another. The modules can be provided with auxiliary features, such as securing detents, limiting devices and bumpers, as desired to make for a more secure and/or easier assembly.

The preferred embodiments of the present invention have been described with some specificity for the sake of illustration, although the invention is not limited to the exact configuration or method s disclosed, as one of ordinary skill in the art will understand the invention from the teachings herein and recognize that many alterations and deviations are possible without departing from the spirit of the invention. Accordingly, it will be understood that the description of the preferred embodiments has been provided to illustrate the present invention and not to limit it. The man of ordinary skill in the art will also recognize that some of the features of the present invention can be used to advantage without the corresponding use of other features. For example, the dovetail projection and complementary dovetail recess described in the present description is a convenient way to connect two modules, but other suitable connections can be substituted, if desired. The mounting pedestal is an optional feature and not required for the use of customizable modules of the present invention. The ABS plastic material is an easy to mold plastic material, but other materials could be used to advantage in the present invention. Further, the present invention is capable of being extended, for example, to having a transparent covering provided over the front surface of the module on any, some or all of the modules, if desired. The backdrop has also been described as optional, if scenery or a mirror is desired to better display the collectible or other object contained in the module. Finally, the configuration shown in FIG. 9 is merely one illustrative configuration, where the arranger can assemble the modules in the configuration desired to fit the space or the desired appearance, and by selectively leaving gaps, can define a display space larger than a single module, as desired.

The material of the module also has been described as plastic in its preferred embodiment, although that material is not required, as other materials could be used to advantage, perhaps with changes in the manufacturing process. Other materials which could be molded include metals and alloys, cement or concrete and other mixtures of materials in a resin base. It is also thought that ceramics or paper mache might be used to advantage in some forms of the present invention, although one would have to consider the costs involved with the manufacturing process and the life of the resulting material. It is also possible to use wood in the present invention, although that might require milling processes to form the interfitting connections between modules.

Having thus described the invention, what is claimed is:

1. An interlocking display module comprising:
a three-dimensional body;
a first flange extending from the three-dimensional body and carrying a projection; and
a second flange extending from a different surface of the three dimensional body and including a recess shaped to receive a projection of the type extending from the first flange, said recess on the second flange of one interlocking display module adapted to receive a projections from a first flange of another similar interlocking display module to join the one module to the another module.

2. An interlocking display module of the type described in claim 1 wherein the module is substantially a rectangular solid with an open front and includes a first flange on the right side and a second flange on the left side of the rectangular solid, whereby the projection on the right side of solid of one module couples with the recess.

3. An interlocking display module of the type described in claim 2 wherein the module further includes a backdrop inserted within the module.

4. An interlocking display module of the type described in claim 2 wherein the module further includes a transparent cover over a front surface of the module.

5. An interlocking display module of the type described in claim 1 wherein the display module and flange are formed of a single piece of ABS plastic.

6. A method of making an interlocking display module comprising the steps of:
creating a mold defining the desired shape of the display module, the mold including a portion which defines the module and flange portions defining the interlocking mechanism, the flange portions including a first dovetail projection and a second recess for receiving a dovetail projection from an other module;
injecting plastic into the mold to form the display module with flange portions having the dovetail projection and the recess for receiving a dovetail projection;
removing the display module from the mold to provide a display module with flanges having a dovetail projection and a recess to receive a dovetail projection from an other module.

7. The method of claim 6 wherein the interlocking display module is substantially in the shape of a rectangular solid and includes flanges on four of the surfaces, including two flanges with dovetail projections and two flanges with recesses for receiving dovetail projections from other display modules.

8. The method of claim 6 wherein the method further includes the step of forming a locating pedestal within the display module.

9. The method of claim 6 wherein the method further includes the step of inserting a backdrop within the display module after the module has been molded.

10. The method of claim 9 wherein step of inserting a backdrop includes the step of inserting a mirror within the module.

11. A one-piece module for coupling with a similar module for displaying thing in a desired orientation, the one-piece module comprising:
A plurality of walls defining a cavity for displaying an object being displayed, including a base wall which includes a mounting pedestal formed integral with the base wall for mounting the object being displayed in a desired position and orientation; and
A coupling mechanism formed integral with the walls, the coupling mechanism including a projection on one side and a recess on the other side, the recess positioned and dimensioned for receiving a projection from a similar module.

12. A one-piece module of the type described in claim 11 wherein the integral coupling mechanism includes a dovetail projection on the one side and the recess on the other side includes a dovetail-shaped recess and the dovetail projection of the module is dimensioned so as to slide within the dovetail recess on an adjacent module and secure the two modules together.

13. A one-piece module of the type described in claim 11 wherein the one-piece module further includes an integral slot formed within the base wall for receiving and retaining a coin in a predetermined location and position for display in conjunction with the object being displayed.

14. A one-piece module of the type described in claim 11 wherein the module includes a rear surface positioned behind the object to be displayed.

15. A one-piece module of the type described in claim 14 wherein the rear surface includes a pictorial display associated with the object being displayed.

16. A module of the type described in claim 14 wherein the rear surface includes a mirror for seeing the rear of the object being displayed.

17. A module of the type described in claim 11 wherein the one-piece module is covered with a separate transparent front surface.
